(19) United States
(12) Patent Application Publication
(10) Pub. No.: US 2003/0097201 A1
(43) Pub. Date: May 22, 2003

(54) Computer controlled garment conveyor retrieval system

(76) Inventor: Paul Kee Min, Dallas, TX (US)

Correspondence Address: ROBERT M. MASON, MASON & PETRUZZI, SUITE 402W, 13601 PRESTON ROAD, DALLAS, TX, 75240, US

(21) Appl. No.: 10/002,849

(22) Filed: Nov. 21, 2001

(51) Int. Cl. G06F 7/00

(52) U.S. Cl. 700/229

(57) ABSTRACT

A computer controlled garment conveyor retrieval system with an operator modifiable electronic input device to a computer, a computer to provide a signal to operate a drive motor for a conveyor, and a sensor to determine the position of the conveyor. A preferred embodiment includes a sensor that determines the position of the conveyor by sensing the passage of section vertical member (or poles). A preferred embodiment includes wherein said sensor determines conveyor position through mechanical means. The sensor and computer work in tandem to position the conveyor to expeditiously retrieve the selected garment. The system can operate with a plurality of conveyors simultaneously.

### CROSS REFERENCES TO RELATED APPLICATION

Not Applicable

### BACKGROUND OF THE INVENTION

This invention relates generally to a garment conveyor system and more particularly to a computer controlled garment conveyor retrieval system. Laundries and dry cleaners utilize conveyor systems to store and move garments. These conveyors are usually divided into a series of sections, each of which store a number of garments on hangers. Sections of the conveyor systems travel on guide rails and can be moved to deliver garments to specific points along the conveying route. These conveyor systems are usually electrically powered and operate to move specific garments to specific points along the conveyor line.

A computerized garment tracking system by Iowa Technologies currently on the market required significant expense and requires the motor system to be modified. The systems tries to estimate the position of the garment holding sections by tracking the revolutions of the motor that drives the guide rail. The position of each garment on the conveyor can be registered in a computer. The computer can then be used to retrieve a specific garment from a location on the conveyor section to the desired station based on motor revolutions. It has been difficult, however, for current systems to automatically and accurately determine the position of each garment as it reaches a predetermined location along the conveyor.

### SUMMARY OF THE INVENTION

An object of the invention is reduced operator intervention in locating and retrieving garments. Another object of the invention is ability to retrofit existing conveyor systems.

A further object of the invention is to provide simple startup and calibration process.

In accordance with a preferred embodiment of the present invention, a computer controlled garment conveyor retrieval system comprises an operator modifiable electronic input device to a computer; a computer to provide a signal to operate a drive motor for a conveyor; and a sensor to determine the position of the conveyor.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the computer controlled garment conveyor retrieval system in accordance with a preferred embodiment of the present invention.

FIG. 2 is a plan view of the invention.

FIG. 3 is a plan view of a portion of the invention showing the garment conveyor and the sensor mounted on the conveyor rail.

FIG. 4 is a schematic diagram illustrating the operation of a portion of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Conveyor systems for storage and movement of garments are used by laundry and dry cleaning facilities. These systems are well know to those skilled in the art and are integral parts of the present invention.

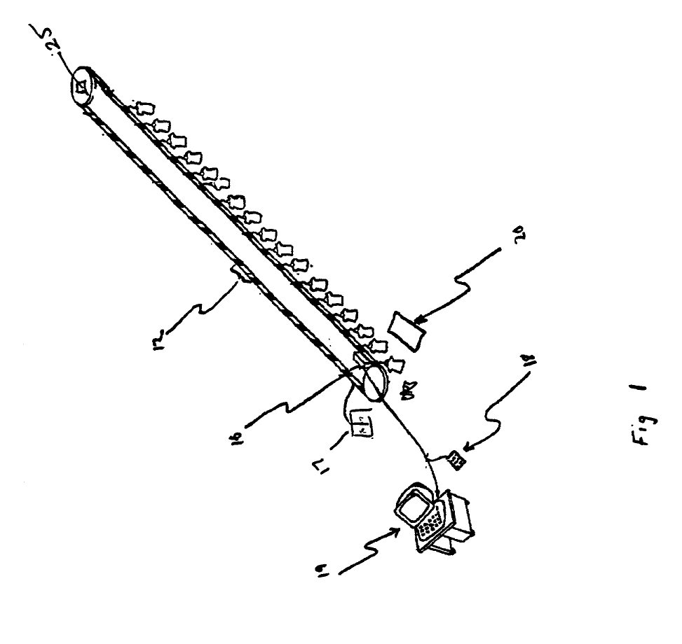

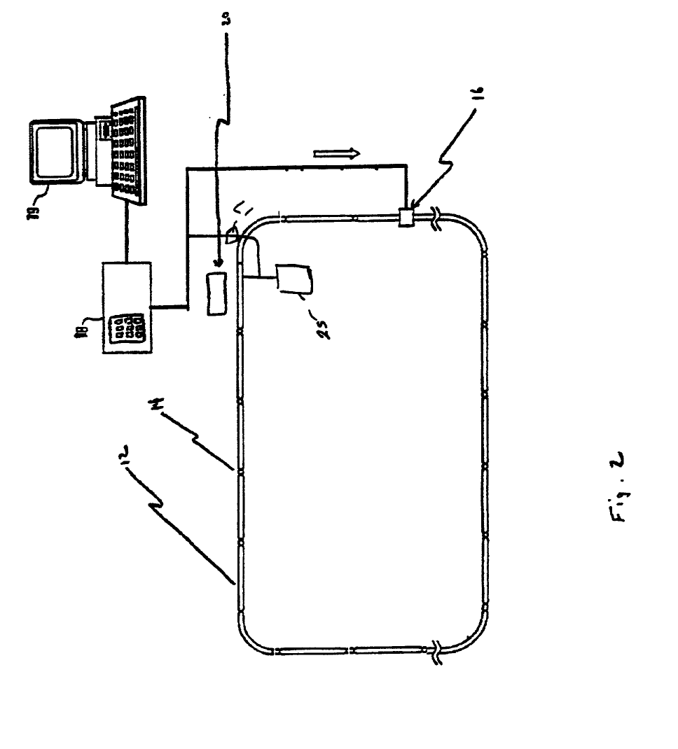

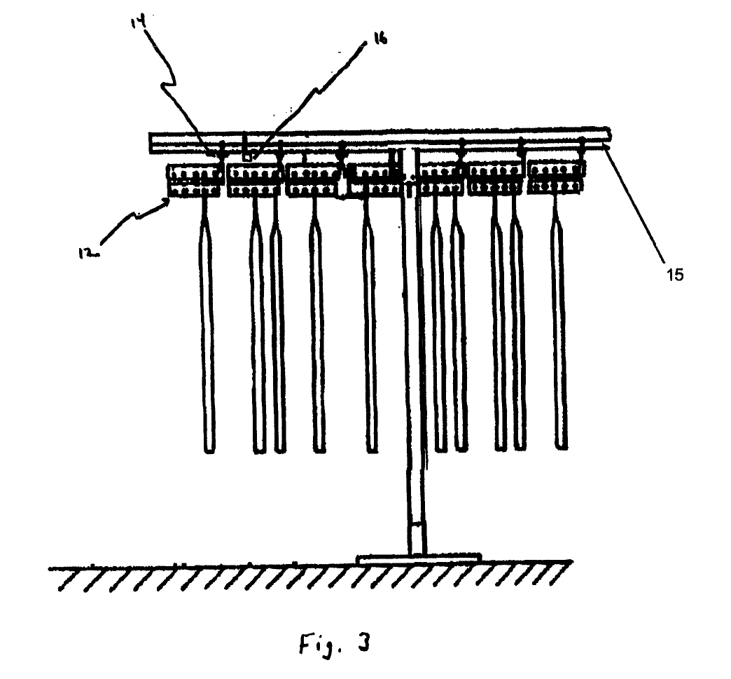

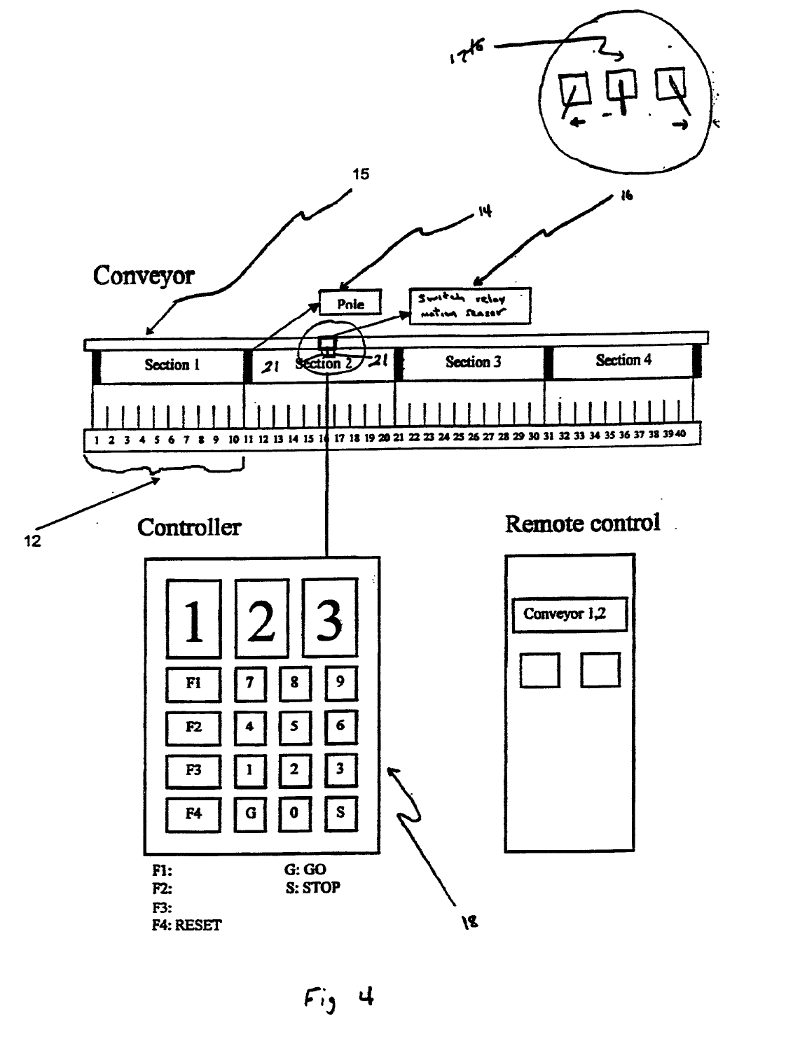

Turning first to FIGS. 1 and 2, it is shown in accordance with the illustrated embodiment of the present invention, a conveyor divided into a series of sections 12, each of which store a number of garments on hangers and typically have ten slots for accepting the hook end of a clothes hanger. As shown in FIGS. 3 and 4, sections 12 of the conveyor systems travel on guide rails 15 and can be moved to deliver garments to specific points, such as an employee pick up point shown in FIG. 1 at 20, along the conveying route. The direction of travel, forward or reverse, is determined by moving switch 17, operatively connected to motor 25. Vertical members or poles 14 support conveyor sections 12 above the facility floor and allow the sections to move along suspended guide rail 15. By way of example, a conveyor system may have 80 sections, thereby having 800 slots for accepting clothes hangers. Each slot would have a unique designation such as 1-10 in section 1, 11-20 in section 2, 321-330 in section 33, and so forth.

As poles 14 pass by any fixed point along the guide rail path it is possible to determine the section position relative to the fixed point. In the preferred construction and illustrated form, sensing device or sensor 16 detects the passing of section pole 14 and relays that information to central computer or computer network 19. A preferred embodiment of sensing device or sensor 16 is shown in FIG. 4 as at least two optical sensors 21. Each optical sensor 21 detects the passage of a pole 14 before it. By placing one optical sensor 21 next to another optical sensor 21, the computer can deter the direction, whether forward or reverse, conveyor is moving from determining which of the two sensors 21 detect passing pole 14 first. The sensor may be optical or use any other means to detect the passing of poles 14.

A system operator using data keypad 18 or computer 19 keyboard enters customer information such as name or ticket number for relay to central computer or computer network (hereinafter computer) 19. The computer compiles this information and merges it with customer garment database to determine the garment location on the conveyor. Alternately, each ticket will have the unique slot location number placed thereon by the person placing the clothes hanger on the conveyor system.

The computer calculates the current position of conveyor section 12 with the desired garment(s) and the location of the desired pick up point 20. The current position is accomplished either by the computer remembering the stopping section from the most recent operation, or by resetting the system. To reset the system, the operator simply keys in the current section 14 number at pick up point 20 and selects a function button from keypad 18 indicating the reset function. The location of the desired slot is determined to be either correlating the ticket number or inputting the unique slot number. The computer then determines the shortest route to move that section 12 to the pick up point. This can be accomplished by simple algorithm knowing the storage location, ending location and total number of slots in the conveyor system.

Computer 19 then signals the conveyor motor 25 to operate in the desired direction, whether forward or reverse. This can be accomplished through switch 17, but not necessarily. By way of example, a conveyor system may have 80 sections, thereby having 800 slots for accepting clothes hangers. Each slot would have a unique designation such as 1-10 in section 1, 11-20 in section 2, 321-330 in section 33, and so forth. As conveyor motor 25 moves conveyor sections 12, optical sensors 21 detects the passing of each section pole 14. That information is relayed back to computer 19 and the conveyor section position is recalculated. This process continues until section 12 nears the desired pick up point. The computer then sends a signal through switch 17 to stop the conveyor motor thereby stopping at the desired section 12. Computer 19 sends a signal to stop the motor so that the desired section 12 is adjacent to the pick up point 20.

The system operator repeats the process until all desired garments are retrieved.

A truncated entry (such as a one key entry for retrieval of the next garment for the same customer) is envisioned to further reduce the operator workload when a series of locations needs to be retrieved.

The ability to use this system with more than one conveyor is achieved after the operator enters the customer information into keypad 18 or computer 19 keyboard, the computer would engage each conveyor simultaneously using the steps listed previously to retrieve customer garments. The operator would simply stop at the operator selected desired pick up point 20 along each conveyor route.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A computer controlled garment conveyor retrieval system comprising:
an operator modifiable electronic input device to a computer;
a computer to provide a signal to operate a drive motor for a conveyor; and
a sensor that determines the position of the conveyor by sensing the passage of section vertical member (or poles) to determine the position of the conveyor.

2. A computer controlled garment conveyor retrieval system as claimed in claim 1 wherein said wherein said sensor determines conveyor position through mechanical means.

3. A computer controlled garment conveyor retrieval system as claimed in claim 1 wherein said sensor determines conveyor position through optical means.

4. A computer controlled garment conveyor retrieval system comprising:
an operator modifiable electronic input device to a computer;
a computer to provide a signal to operate a drive motor for a conveyor;
a sensor that determines the position of the conveyor by sensing the passage of section vertical member (or poles);
an input device to provide electronic signals to the computer based on signals from the sensor; and
the input device and computer can operate a plurality of conveyors.

5. A computer controlled garment conveyor retrieval system as claimed in claim 4 wherein said wherein said sensor determines conveyor position through mechanical means.

6. A computer controlled garment conveyor retrieval system as claimed in claim 5 wherein said sensor determines conveyor position through optical means.

7. A computer controlled garment conveyor retrieval system comprising:
an operator modifiable electronic input device to a computer;
a computer to provide a signal to operate a drive motor for a conveyor;
a sensor mounted on the conveyor frame that determines the position of the conveyor by sensing the passage of section vertical member (or poles);
an input device to provide electronic signals to the computer based on signals from the sensor; and
input device and computer can operate a plurality of conveyors.
